(19) United States
(12) Patent Application Publication
(10) Pub. No.: US 2026/0004738 A1
(43) Pub. Date: Jan. 1, 2026

(54) GATE DRIVER, DISPLAY DEVICE, AND ELECTRONIC APPARATUS

(71) Applicant: SAMSUNG DISPLAY CO., LTD., YONGIN-SI (KR)

(72) Inventors: JUNKI JEONG, YONGIN-SI (KR); HYUNJOON KIM, YONGIN-SI (KR); YOUNGWAN SEO, YONGIN-SI (KR); JUNGHWAN HWANG, YONGIN-SI (KR)

(21) Appl. No.: 19/066,335

(22) Filed: Feb. 28, 2025

(30) Foreign Application Priority Data
Jun. 28, 2024 (KR) 10-2024-0084954

(51) Int. Cl. G09G 3/3266; G09G 3/3233

(52) U.S. Cl. CPC G09G 3/3266; G09G 3/3233; G09G 2300/0819; G09G 2300/0852; G09G 2300/0861; G09G 2310/0283; G09G 2310/0286; G09G 2310/06; G09G 2330/023

(57) ABSTRACT

A display device includes a display panel having a plurality of pixel rows arranged in a first direction and each including a plurality of pixels, a first gate driver including a first stage having a first gate signal as a first output to each of the plurality of pixel rows, and a second gate driver including a second stage having a second gate signal as a second output to each of the plurality of pixel rows, the second stage being alternately arranged with the first stage in the first direction. The first gate driver and the second gate driver share a first clock signal. Each of the first stage and the second stage is connected to at least four pixel rows among the plurality of pixel rows.

### CROSS-REFERENCE TO RELATED APPLICATION(S)

This application claims priority under 35 USC § 119 to Korean Patent Application No. 10-2024-0084954, filed on Jun. 28, 2024 in the Korean Intellectual Property Office (KIPO), the entire disclosure of which is incorporated by reference herein.

### FIELD

The present disclosure relates to a display device. More particularly, the present disclosure relates to a gate driver with low power consumption and small area, a display device including the gate driver, and an electronic apparatus including the display device.

### INTRODUCTION

A display device may include a display panel for displaying an image, and a gate driver for providing gate signals to the display panel. The gate driver may include first to n^{th} gate drivers with stages for generating first to n^{th} gate signals, where n is a natural number greater than 1.

When the number of stages included in the first to n^{th} gate drivers increases, power consumption of the gate driver may increase, and thus power consumption of the display device may increase. Further, when the first to n^{th} gate drivers are arranged in a row direction, an area of the gate driver may increase, and a dead space of the display device may also increase.

### SUMMARY

An embodiment of the present disclosure provides a gate driver having low power consumption and a small area.

An embodiment of the present disclosure provides a display device having low power consumption and a small dead space.

An embodiment of the present disclosure provides an electronic apparatus having low power consumption.

A display device according to an embodiment includes a display panel including a plurality of pixel rows arranged in a first direction, each pixel row including a plurality of pixels, a first gate driver including a first stage having a first gate signal as a first output to each of the plurality of pixel rows, and a second gate driver including a second stage having a second gate signal as a second output to each of the plurality of pixel rows, the second stage being alternately arranged with the first stage in the first direction. The first gate driver and the second gate driver share a first clock signal. Each of the first stage and the second stage is connected to at least four pixel rows among the plurality of pixel rows.

In an embodiment, each of the first stage and the second stage may be connected to an even number of pixel rows among the plurality of pixel rows.

In an embodiment, each of the first stage and the second stage may be connected to four, six, or eight pixel rows among the plurality of pixel rows.

In an embodiment, the display device may further include a third gate driver including a third stage having a third gate signal as a third output to each of the plurality of pixel rows, and a fourth gate driver including a fourth stage having a fourth gate signal as a fourth output to each of the plurality of pixel rows, the fourth stage being alternately arranged with the third stage in the first direction. The third gate driver and the fourth gate driver may share a second clock signal. Each of the third stage and the fourth stage may be connected to at least four pixel rows among the plurality of pixel rows.

In an embodiment, the first gate driver, the second gate driver, the third gate driver, and the fourth gate driver may be positioned towards a first side of the plurality of pixel rows in a second direction crossing the first direction.

In an embodiment, the first gate driver and the second gate driver may be positioned towards a first side of the plurality of pixel rows in a second direction crossing the first direction. The third gate driver and the fourth gate driver may be positioned towards a second side of the plurality of pixel rows opposite to the first side in the second direction.

In an embodiment, the display device may further include a fifth gate driver including a fifth stage having a fifth gate signal as a fifth output to the plurality of pixel rows. The fifth stage may include a plurality of sub-stages, each of which may be connected to one respective pixel row among the plurality of pixel rows.

In an embodiment, each of the pixels may include a light-emitting element, a first transistor which controls a driving current flowing through the light-emitting element, a second transistor which provides a data voltage to a gate of the first transistor in response to the fifth gate signal, a third transistor which provides a reference voltage to the gate of the first transistor in response to the fourth gate signal, a fourth transistor which provides an initialization voltage to a first electrode of the light-emitting element in response to the second gate signal, a fifth transistor which blocks a connection between a first electrode of the first transistor and a first power voltage in response to the first gate signal, and a sixth transistor which blocks a connection between a second electrode of the first transistor and a second power voltage in response to the third gate signal.

In an embodiment, each of the pixels may include a light-emitting element, a first transistor which controls a driving current flowing through the light-emitting element, a second transistor which provides a data voltage to a gate of the first transistor in response to the fifth gate signal, a third transistor which compensates a threshold voltage of the first transistor in response to the fourth gate signal, a fourth transistor which provides an initialization voltage to the gate of the first transistor in response to the third gate signal, a fifth transistor which blocks a connection between a first electrode of the first transistor and a first power voltage in response to the first gate signal, a sixth transistor which blocks a connection between a second electrode of the first transistor and a second power voltage in response to the first gate signal, and a seventh transistor which provides a second initialization voltage to a first electrode of the light-emitting element in response to the second gate signal.

In an embodiment, each of the pixels may further include an eighth transistor having a bias voltage as a bias output to the first electrode of the first transistor in response to the second gate signal.

In an embodiment, the first clock signal may swing between a low level and a high level in an address scan period and a self-scan period. The second clock signal may swing between the low level and the high level in the address scan period, and may maintain the low level or the high level in the self-scan period.

In an embodiment, the first stage may include a first logic circuit which controls a signal of a first control node and a signal of a first inverting control node in response to a first input signal and the first clock signal, and a first buffer circuit which outputs the first gate signal in response to the signal of the first control node and the signal of the first inverting control node. A width of the first buffer circuit in a second direction crossing the first direction may be greater than a width of the first logic circuit in the second direction.

In an embodiment, the second stage may include a second logic circuit which controls a signal of a second control node and a signal of a second inverting control node in response to a second input signal and the first clock signal, and a second buffer circuit which outputs the second gate signal in response to the signal of the second control node and the signal of the second inverting control node. A width of the second buffer circuit in the second direction may be greater than a width of the second logic circuit in the second direction.

In an embodiment, each of the first stage and the second stage may include a plurality of transistors. Each of the transistors may be an N-type oxide semiconductor transistor.

A gate driver according to an embodiment includes a first gate driver including a first stage having a first gate signal as a first output to each of a plurality of pixel rows, and a second gate driver including a second stage having a second gate signal as a second output to each of the plurality of pixel rows, the second stage being alternately arranged with the first stage in a first direction. The first gate driver and the second gate driver share a first clock signal. Each of the first stage and the second stage is connected to at least four pixel rows among the plurality of pixel rows.

In an embodiment, the gate driver may further include a third gate driver including a third stage having a third gate signal as a third output to each of the plurality of pixel rows, and a fourth gate driver including a fourth stage having a fourth gate signal as a fourth output to each of the plurality of pixel rows, the fourth stage being alternately arranged with the third stage in the first direction. The third gate driver and the fourth gate driver may share a second clock signal. Each of the third stage and the fourth stage may be connected to at least four pixel rows among the plurality of pixel rows.

In an embodiment, the gate driver may further include a fifth gate driver including a fifth stage having a fifth gate signal as a fifth output to the plurality of pixel rows. The fifth stage may include a plurality of sub-stages, each of which may be connected to one respective pixel row among the plurality of pixel rows.

In an embodiment, the first clock signal may swing between a low level and a high level in an address scan period and a self-scan period. The second clock signal may swing between the low level and the high level in the address scan period, and may maintain the low level or the high level in the self-scan period.

In an embodiment, the first stage may include a first logic circuit which controls a signal of a first control node and a signal of a first inverting control node in response to a first input signal and the first clock signal, and a first buffer circuit which outputs the first gate signal in response to the signal of the first control node and the signal of the first inverting control node. A width of the first buffer circuit in a second direction crossing the first direction may be greater than a width of the first logic circuit in the second direction.

An electronic apparatus according to an embodiment includes a processor which generates image data, and a display device which displays an image based on the image data. The display device includes a display panel including a plurality of pixel rows arranged in a first direction and each including a plurality of pixels, a first gate driver including a first stage having a first gate signal as a first output to each of the plurality of pixel rows, and a second gate driver including a second stage having a second gate signal as a second output to each of the plurality of pixel rows, the second stage being alternately arranged with the first stage in the first direction. The first gate driver and the second gate driver share a first clock signal. Each of the first stage and the second stage is connected to at least four pixel rows among the plurality of pixel rows.

In a gate driver according to an embodiment, the stages of the first and second gate drivers are alternately arranged in a column direction, and each of the stages of the first and second gate drivers is connected to at least four pixel rows, so that the power consumption and the area of the gate driver may be reduced.

A display device according to an embodiment includes a gate driver with low power consumptions and a small area, so that the power consumption and the dead space of the display device may similarly be low and small, respectively.

An electronic apparatus according to an embodiment includes a display device with low power consumption, so that the power consumption of the electronic apparatus may be low.

### BRIEF DESCRIPTION OF THE DRAWINGS

Illustrative, non-limiting embodiments will be more clearly understood from the following detailed description when taken in conjunction with the accompanying drawings.

FIG. 1 is a block diagram showing a display device according to an embodiment.

FIG. 2 is a plan view diagram showing an example of a portion of the display device of FIG. 1.

FIG. 3 is a plan view diagram showing an example of a portion of the display device of FIG. 1.

FIG. 4 is a plan view diagram showing an example of a portion of the display device of FIG. 1.

FIG. 5 is a plan view diagram showing an example of a portion of a display device according to a comparative example.

FIG. 6 is a plan view diagram showing an example of a portion of the display device of FIG. 1.

FIG. 7 is a circuit diagram showing an example of a pixel of FIG. 1.

FIG. 8 is a timing diagram showing gate signals provided to the pixel of FIG. 7.

FIG. 9 is a circuit diagram showing a first stage which provides a first gate signal to the pixel of FIG. 7.

FIG. 10 is a layout diagram showing the first stage of FIG. 9.

FIG. 11 is a circuit diagram showing a second stage which provides a second gate signal to the pixel of FIG. 7.

FIG. 12 is a layout diagram showing the second stage of FIG. 11.

FIG. 13 is a circuit diagram showing an example of the pixel of FIG. 1.

FIG. 14 is a timing diagram showing gate signals provided to the pixel of FIG. 13.

FIG. 15 is a timing diagram showing clock signals according to an embodiment.

FIG. 16 is a block diagram showing an electronic apparatus according to an embodiment.

### DETAILED DESCRIPTION

Hereinafter, a gate driver, a display device, and an electronic apparatus according to illustrative embodiments of the present disclosure will be described in detail with reference to the accompanying drawings. The same or similar reference numerals may be used for the same or similar elements in the accompanying drawings.

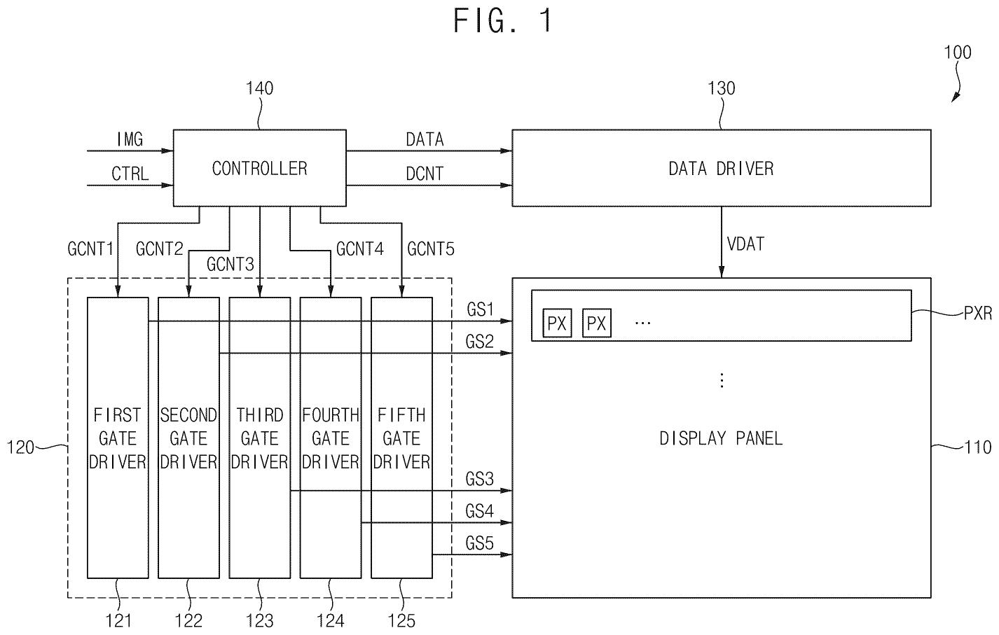

FIG. 1 illustrates a display device, generally indicated by the reference numeral 100, according to an embodiment.

Referring to FIG. 1, the display device 100 may include a display panel 110, a gate driver 120 connected to the display panel, a data driver 130 connected to the display panel, and a controller 140 connected to the gate driver and the data driver.

The display panel 110 may include a plurality of pixel rows PXR. Each of the pixel rows PXR may include a plurality of pixels PX. Each of the pixels PX may emit light in response to signals from the gate driver including a first gate signal GS1, a second gate signal GS2, a third gate signal GS3, a fourth gate signal GS4, a fifth gate signal GS5, and a signal from the data driver including a data voltage VDAT.

The gate driver 120 may include a first gate driver 121, a second gate driver 122, a third gate driver 123, a fourth gate driver 124, and a fifth gate driver 125.

The first gate driver 121 may provide first gate signals GS1 to the pixel rows PXR. The first gate driver 121 may generate the first gate signals GS1 based on a first gate control signal GCNT1 from the controller 140. The first gate control signal GCNT1 may include a first clock signal and a first gate start signal.

The second gate driver 122 may provide second gate signals GS2 to the pixel rows PXR. The second gate driver 122 may generate the second gate signals GS2 based on a second gate control signal GCNT2 from the controller 140. The second gate control signal GCNT2 may include the first clock signal and a second gate start signal.

The third gate driver 123 may provide third gate signals GS3 to the pixel rows PXR. The third gate driver 123 may generate the third gate signals GS3 based on a third gate control signal GCNT3 from the controller 140. The third gate control signal GCNT3 may include a second clock signal and a third gate start signal.

The fourth gate driver 124 may provide fourth gate signals GS4 to the pixel rows PXR. The fourth gate driver 124 may generate the fourth gate signals GS4 based on a fourth gate control signal GCNT4 from the controller 140. The fourth gate control signal GCNT4 may include the second clock signal and a fourth gate start signal.

The fifth gate driver 125 may provide fifth gate signals GS5 to the pixel rows PXR. The fifth gate driver 125 may generate the fifth gate signals GS5 based on a fifth gate control signal GCNT5 from the controller 140. The fifth gate control signal GCNT5 may include a third clock signal and a fifth gate start signal.

The data driver 130 may provide data voltages VDAT to the pixels PX. The data driver 130 may generate the data voltages VDAT based on a data signal DATA and a data control signal DCNT from the controller 140. The data driver 130 may convert the digital data signal DATA into the analog data voltages VDAT. The data control signal DCNT may include a data clock signal, a load signal, and/or the like.

The controller 140 may control an operation and and/or or driving of the gate driver 120 and an operation and/or driving of the data driver 130. The controller 140 may provide the first to fifth gate control signals GCNT1, GCNT2, GCNT3, GCNT4, and GCNT5 to the first to fifth gate drivers 121, 122, 123, 124, and 125, respectively; and may provide the data signal DATA and the data control signal DCNT to the data driver 130. The controller 140 may generate the first to fifth gate control signals GCNT1, GCNT2, GCNT3, GCNT4, and GCNT5, the data signal DATA, and the data control signal DCNT based on received image data IMG and a received control signal CTRL. The controller 140 may convert the image data IMG into the data signal DATA. The data control signal DCNT may include a master clock signal, a horizontal synchronization signal, a vertical synchronization signal, a data enable signal, and/or the like.

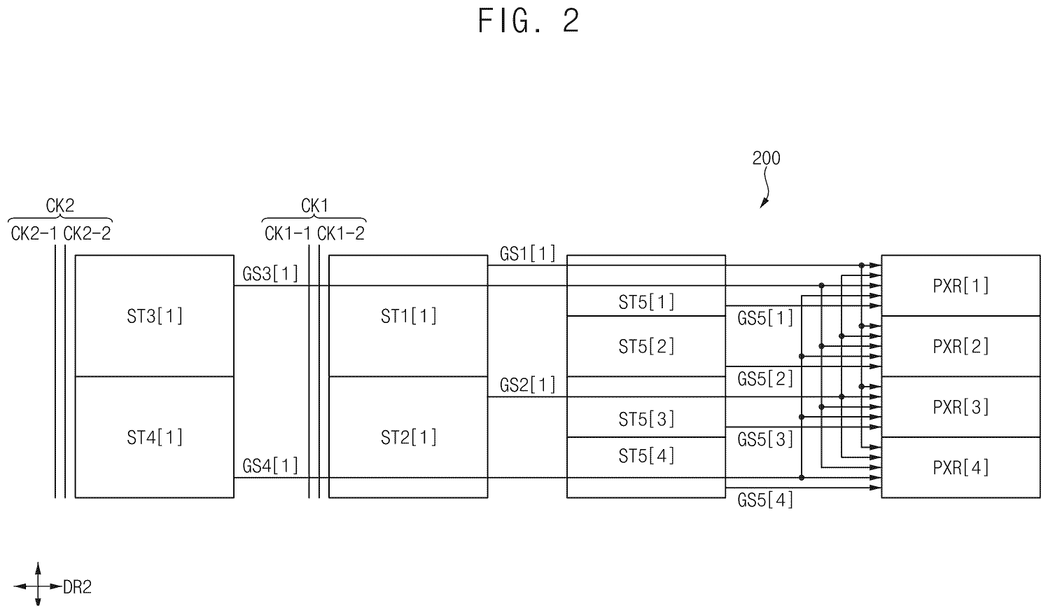

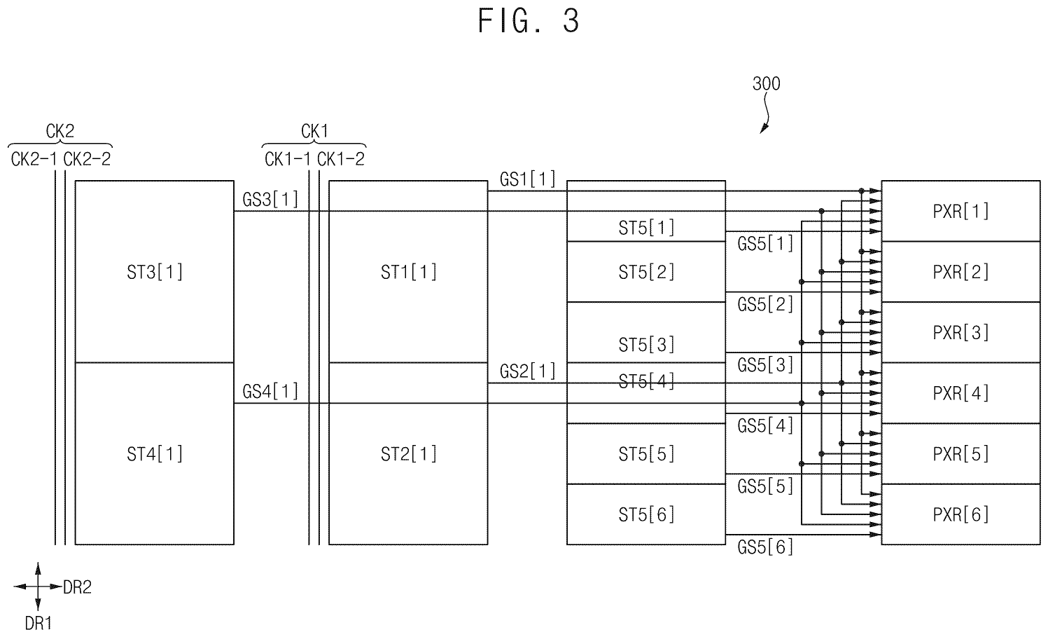

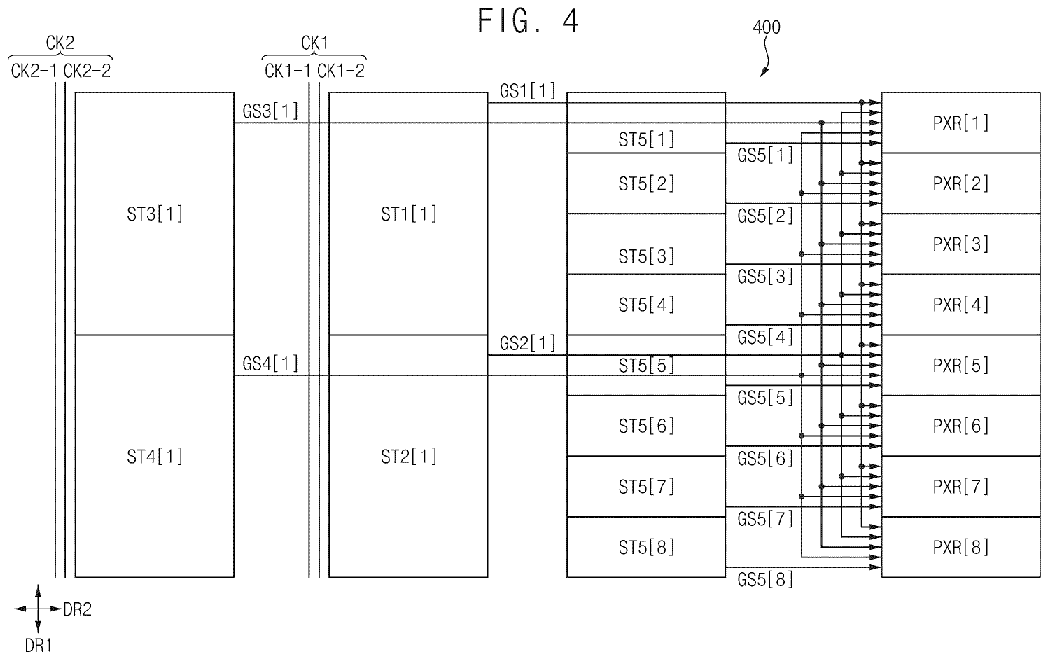

FIG. 2 illustrates an example of a portion of the display device 100 of FIG. 1, generally indicated by the reference numeral 200. FIG. 3 illustrates an example of a portion of the display device 100 of FIG. 1, generally indicated by the reference numeral 300. In addition, FIG. 4 illustrates an example of a portion of the display device 100 of FIG. 1, generally indicated by the reference numeral 400.

Referring to FIGS. 1 through 4, the pixel rows PXR may be arranged in a first direction DR1. The first gate signal GS1, the second gate signal GS2, the third gate signal GS3, the fourth gate signal GS4, and the fifth gate signal GS5 may be applied to each of the pixel rows PXR.

The first gate driver 121 may include first stages ST1 that output the first gate signals GS1, respectively, and the second gate driver 122 may include second stages ST2 that output the second gate signals GS2, respectively. The first stages ST1 and the second stages ST2 may be alternately arranged in the first direction DR1.

The first gate driver 121 and the second gate driver 122 may receive the first clock signal CK1, and may share the first clock signal CK1. The first clock signal CK1 may include a first-first clock signal CK1-1 and a first-second clock signal CK1-2. The first-second clock signal CK1-2 may be a signal in which the first-first clock signal CK1-1 is shifted by half a period from the first-first clock signal CK1-1.

The third gate driver 123 may include third stages ST3 that output the third gate signals GS3, respectively, and the fourth gate driver 124 may include fourth stages ST4 that output the fourth gate signals GS4, respectively. The third stages ST3 and the fourth stages ST4 may be alternately arranged in the first direction DR1.

The third gate driver 123 and the fourth gate driver 124 may receive the second clock signal CK2, and may share the second clock signal CK2. The second clock signal CK2 may include a second-first clock signal CK2-1 and a second-second clock signal CK2-2. The second-second clock signal CK2-2 may be a signal in which the second-first clock signal CK2-1 is shifted by half a period from the second-first clock signal CK2-1.

Each of the first stage ST1, the second stage ST2, the third stage ST3, and the fourth stage ST4 may be connected to at least four pixel rows PXR. For example, each of the first stage ST1, the second stage ST2, the third stage ST3, and the fourth stage ST4 may provide a respective gate signal to at least four pixel rows PXR. In an embodiment, each of the first stage ST1, the second stage ST2, the third stage ST3, and the fourth stage ST4 may be connected to an even number of at least four pixel rows PXR.

In an embodiment, as illustrated in FIG. 2, each of the first stage ST1, the second stage ST2, the third stage ST3, and the fourth stage ST4 may be connected to four pixel rows PXR[1]-PXR[4]. In an embodiment, as illustrated in FIG. 3, each of the first stage ST1, the second stage ST2, the third stage ST3, and the fourth stage ST4 may be connected to six pixel rows PXR[1]-PXR[6]. In an embodiment, as illustrated in FIG. 4, each of the first stage ST1, the second stage ST2, the third stage ST3, and the fourth stage ST4 may be connected to eight pixel rows PXR[1]-PXR[8].

The fifth gate driver 125 may include fifth sub-stages ST5[1-4] that output fifth gate signals GS5[1-4], respectively. The fifth sub-stages ST5[1-4] may be arranged in the first direction DR1.

Each fifth sub-stage ST5[1-4] may be connected to one pixel row PXR[1-4], respectively. For example, the fifth sub-stage ST5[3] may provide one fifth gate sub-signal GS5[3] to one pixel row PXR[3].

In an embodiment, the first gate driver 121 paired with the second gate driver 122, and the third gate driver 123 paired with the fourth gate driver 124, may each be positioned towards a first side of the pixel rows PXR in a second direction DR2 crossing the first direction DR1.

In an embodiment, the first gate driver 121 paired with the second gate driver 122, and the third gate driver 123 paired with the fourth gate driver 124, may be positioned towards the first side of the pixel rows PXR and towards a second side of the pixel rows PXR opposite to the first side in the second direction DR2, respectively.

The fifth gate driver 125 may be positioned towards the first side and towards the second side of the pixel rows PXR in the second direction DR2.

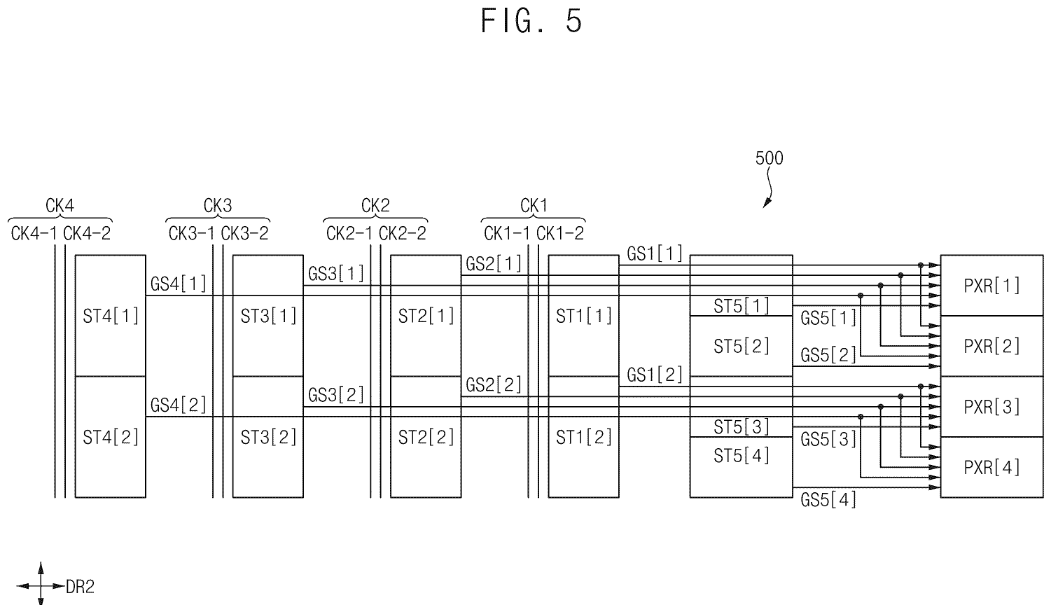

FIG. 5 illustrates an example of a portion of a display device according to a comparative example, generally indicated by the reference numeral 500.

Referring to FIG. 5, in the comparative example, the first sub-stages ST1[1-2] may be arranged in the first direction DR1, and may receive a first clock signal CK1. The second sub-stages ST2[1-2] may be arranged in the first direction DR1, may be adjacent to the first sub-stages ST1[1-2] in the second direction DR2, and may receive a second clock signal CK2. The third sub-stages ST3[1-2] may be arranged in the first direction DR1, may be adjacent to the second sub-stages ST2[1-2] in the second direction DR2, and may receive a third clock signal CK3. The fourth sub-stages ST4[1-2] may be arranged in the first direction DR1, may be adjacent to the third sub-stages ST3[1-2] in the second direction DR2, and may receive a fourth clock signal CK4.

In the comparative example, each of the first sub-stages ST1[1-2], the second sub-stages ST2[1-2], the third sub-stages ST3[1-2], and the fourth sub-stages ST4[1-2] may be connected to two pixel rows PXR. For example, each of the first sub-stage ST1[2], the second sub-stage ST2[2], the third sub-stage ST3[2], and the fourth sub-stage ST4[2] may provide a respective gate signal to two pixel rows PXR[3-4].

In the comparative example, as the number of stages connected to the pixel rows PXR[1-4] increases (e.g., the number of the first through fourth sub-stages ST1[1-2]-ST4[1-2] connected to four pixel rows PXR[1-4] is eight), and the number of clock signals applied to the stages increases (e.g., the first through fourth clock signals CK1-CK4 are applied to the first through fourth sub-stages ST1-ST4), power consumption of the gate driver may increase. In the present embodiment, as the number of stages connected to the pixel rows PXR is minimized (e.g., the number of the first through fourth stages connected to the four pixel rows PXR is four rather than eight) and the number of clock signals applied to the stages is minimized (e.g., the first and second clock signals CK1 and CK2 are applied to the first through fourth stages ST1-ST4), power consumption of the gate driver 120 may be minimized. As the display device 100 according to the present embodiment includes the gate driver 120 with the minimized power consumption, power consumption of the display device 100 may also be minimized.

A power consumption P of the gate driver may be calculated using Equation 1:

$$P = {nCV}^{2} f \qquad [ Equation 1 ]$$

In Equation 1, n is the number of wires transmitting the clock signal, C is the capacitance of the gate driver, V is the voltage across the gate driver, and f is the frequency of the clock signal. In the comparative example, n may be 8, and f may be 120 Hz. In the present embodiment, since the first and second stages ST1 and ST2 share the first clock signal CK1 and the third and fourth stages ST3 and ST4 share the second clock signal CK2, n may be 4, and since the number of pixel rows connected to one stage in the present embodiment is half of the number of pixel rows connected to one stage in the comparative example, f may be 60 Hz. Accordingly, the power consumption of the gate driver 120 according to the present embodiment may be about 25% of the power consumption of the gate driver according to the comparative example.

In the comparative example, since the stages ST1-ST5 are positioned in five columns towards he first side of the pixel rows PXR in the second direction DR2, the area of the gate driver may be large. In the present embodiment, since the stages ST1-ST5 are positioned in three columns towards the first side of the pixel rows PXR in the second direction DR2, the area of the gate driver 120 may be minimized. As the display device 100 according to the present embodiment includes the gate driver 120 with the reduced area, a dead space of the display device 100 may be minimized.

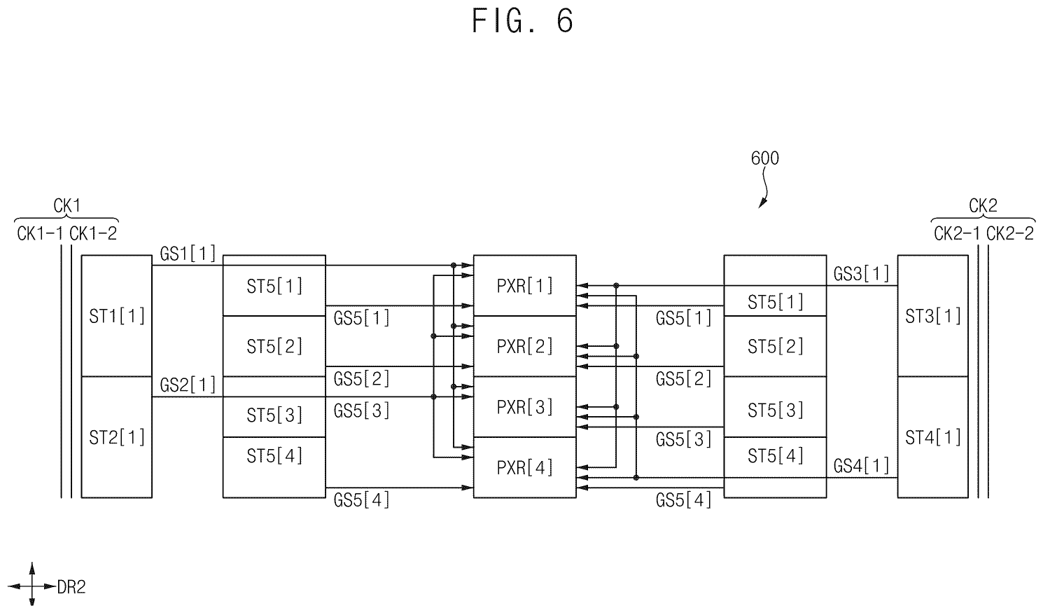

FIG. 6 illustrates an example of a portion of the display device 100 of FIG. 1, generally indicated by the reference numeral 600.

Referring to FIG. 6, in an embodiment, the first gate driver 121 and the second gate driver 122 may be positioned towards the first side of the pixel rows PXR in the second direction DR2, and the third gate driver 123 and the fourth gate driver 124 may be positioned towards the second side of the pixel rows PXR in the second direction DR2.

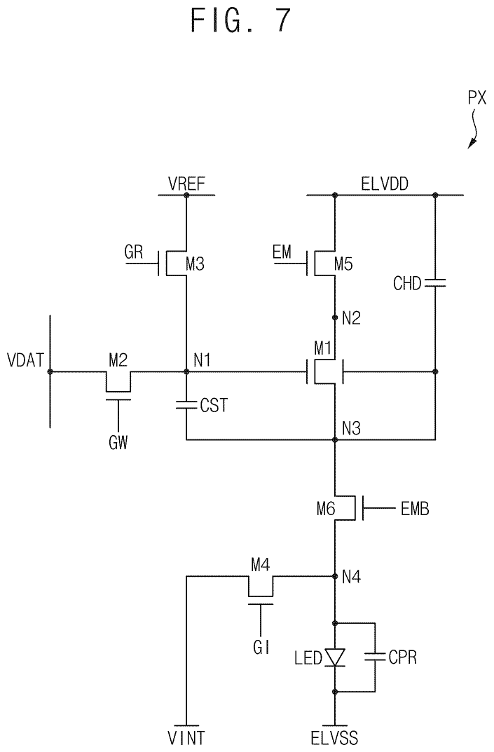

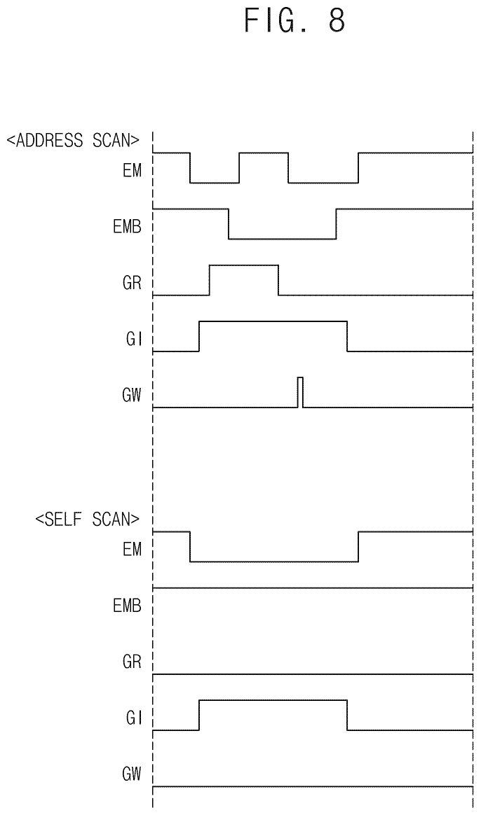

FIG. 7 illustrates an example of the pixel PX of FIG. 1. FIG. 8 illustrates timings of gate signals EM, EMB, GR, GI, and GW provided to the pixel PX of FIG. 7.

Referring to FIGS. 7 and 8, the pixel PX may receive a write gate signal GW, a reference gate signal GR, an initialization gate signal GI, an emission signal EM, an inverted emission signal EMB, and the data voltage VDAT. The first gate signal GS1, the second gate signal GS2, the third gate signal GS3, the fourth gate signal GS4, and the fifth gate signal GS5 described with reference to FIGS. 1 through 6 may be the emission signal EM, the initialization gate signal GI, the inverted emission signal EMB, the reference gate signal GR, and the write gate signal GW, respectively, without limitation thereto. As described below with reference to the illustrative examples of FIGS. 7 through 12, EM, GI, EMB, GR, and GW represent the first gate signal, the second gate signal, the third gate signal, the fourth gate signal, and the fifth gate signal, respectively.

The pixel PX may include a light-emitting element LED, a first transistor M1 connected to the light-emitting element, a second transistor M2 connected to the first transistor, a third transistor M3 connected to the second transistor, a fourth transistor M4 connected to the first transistor, a fifth transistor M5 connected to the first transistor, a sixth transistor M6 connected between the first transistor and the light-emitting element, a storage capacitor CST connected between the first transistor and the third transistor, a hold capacitor CHD connected to the storage capacitor, and a parasitic capacitor CPR connected across the light-emitting element.

The light-emitting element LED may emit light with a luminance corresponding to a driving current. The light-emitting element LED may include a first electrode (e.g., an anode) connected to a fourth node N4 and a second electrode (e.g., a cathode) that receives a second power voltage ELVSS. In an embodiment, the light-emitting element LED may be one of an organic light-emitting diode, an inorganic light-emitting diode, a quantum dot light-emitting diode, and/or a micro light-emitting diode.

The first transistor M1 may control the driving current flowing through the light-emitting element LED. The first transistor M1 may include a gate connected to a first node N1, a first electrode connected to a second node N2, and a second electrode connected to a third node N3. In an embodiment, the first transistor M1 may further include a back gate connected to the third node N3.

The second transistor M2 may provide the data voltage VDAT to the gate of the first transistor M1 in response to the fifth gate signal GW. The second transistor M2 may include a gate that receives the fifth gate signal GW, a first electrode that receives the data voltage VDAT, and a second electrode connected to the first node N1.

The third transistor M3 may provide a reference voltage VREF to the gate of the first transistor M1 in response to the fourth gate signal GR. The third transistor M3 may include a gate that receives the fourth gate signal GR, a first electrode that receives the reference voltage VREF, and a second electrode connected to the first node N1.

The fourth transistor M4 may provide an initialization voltage VINT to the first electrode of the light-emitting element LED in response to the second gate signal GI. The fourth transistor M4 may include a gate that receives the second gate signal GI, a first electrode that receives the initialization voltage VINT, and a second electrode connected to the fourth node N4.

The fifth transistor M5 may block a connection between the first electrode of the first transistor M1 and a first power voltage ELVDD in response to the first gate signal EM. The fifth transistor M5 may include a gate that receives the first gate signal EM, a first electrode that receives the first power voltage ELVDD, and a second electrode connected to the second node N2.

The sixth transistor M6 may block a connection between the second electrode of the first transistor M1 and the second power voltage ELVSS in response to the third gate signal EMB. The sixth transistor M6 may include a gate that receives the third gate signal EMB, a first electrode connected to the third node N3, and a second electrode connected to the fourth node N4.

In an embodiment, each of the first transistor M1, the second transistor M2, the third transistor M3, the fourth transistor M4, the fifth transistor M5, and the sixth transistor M6 may be an N-type oxide semiconductor transistor.

The storage capacitor CST may store a signal of the first node N1. The storage capacitor CST may include a first electrode connected to the first node N1 and a second electrode connected to the third node N3.

The hold capacitor CHD may store a signal of the third node N3. The hold capacitor CHD may include a first electrode connected to the third node N3 and a second electrode that receives the first power voltage ELVDD.

The parasitic capacitor CPR may be connected in parallel with the light-emitting element LED. The parasitic capacitor CPR may be an internal capacitor of the light-emitting element LED.

In an address scan period in which the data voltage VDAT is written to the pixel PX, the first gate signal EM may include two pulses, and each of the second to fifth gate signals GI, EMB, GR, and GW may include a respective pulse. In the address scan period, the first transistor M1 may be initialized by the pulse of the fourth gate signal GR, the light-emitting element LED may be initialized by the pulse of the second gate signal GI, a threshold voltage of the first transistor M1 may be compensated in a source follower manner by a first pulse of the first gate signal EM, the data voltage VDAT may be written to the first transistor M1 by the pulse of the fifth gate signal GW, and the driving current corresponding to the data voltage VDAT may flow through the light-emitting element LED by a second pulse of the first gate signal EM and the pulse of the third gate signal EMB.

In a self-scan period in which the data voltage VDAT is not written to the pixel PX, each of the first and second gate signals EM and GI may include a pulse, and each of the third to fifth gate signals EMB, GR, and GW need not include a pulse. In the self-scan period, the light-emitting element LED may be initialized by the pulse of the second gate signal GI, and the driving current corresponding to the data voltage VDAT written in the address scan period may flow through the light-emitting element LED by the pulse of the first gate signal EM.

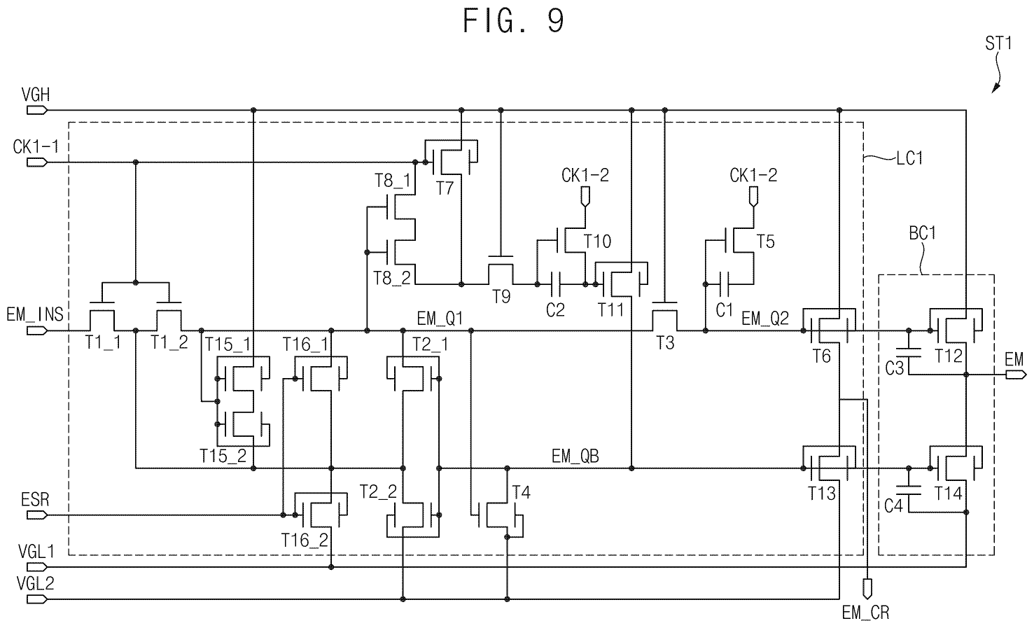

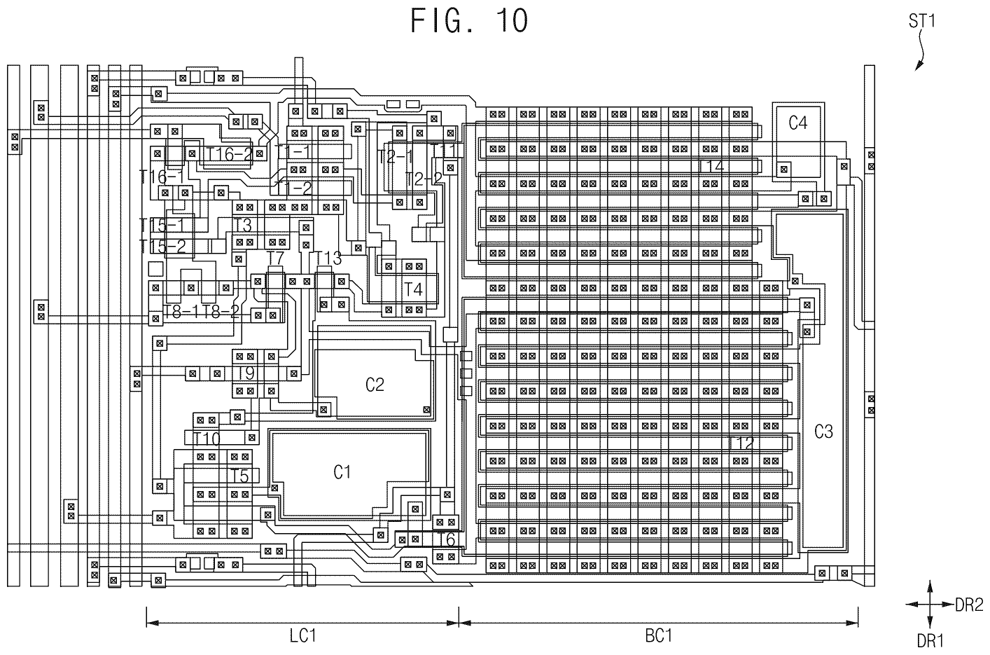

FIG. 9 illustrates the first stage ST1 which provides the first gate signal EM to the pixel PX of FIG. 7. FIG. 10 further illustrates the first stage ST1 of FIG. 9.

Referring to FIGS. 9 and 10, the first stage ST1 may receive a first input signal EM_INS, the first clock signal CK1 including first-first clock sub-signal CK1-1 and first-second clock sub-signal CK1-2, a high gate voltage VGH, a first low gate voltage VGL1, a second low gate voltage VGL2, and a reset signal ESR. The first stage ST1 may output the first gate signal EM and a first carry signal EM_CR. The first stage ST1 may include a first logic circuit LC1 and a first buffer circuit BC1.

The first logic circuit LC1 may control a signal of a first-first control node EM_Q1 and a first-second control node EM_Q2, and a signal of a first inverting control node EM_QB, in response to the first input signal EM_INS and the first clock signal CK1 including first clock sub-signals CK1-1 and CK1-2. The first-first control node EM_Q1 and the first-second control node EM_Q2 may be connected in series with a transistor connected between them. The first logic circuit LC1 may include a first transistor T1 including first sub-transistors T1_1 and T1_2, a second transistor T2 including second sub-transistors T2_1 and T2_2, the third transistor T3, a fourth transistor T4, a fifth transistor T5, a sixth transistor T6, a seventh transistor T7, an eighth transistor T8_1 and T8_2, a ninth transistor T9, a tenth transistor T10, an eleventh transistor T11, a thirteenth transistor T13, a fifteenth transistor T15_1 and T15_2, a sixteenth transistor T16_1 and T16_2, a first capacitor C1, and a second capacitor C2.

The first transistor T1 including first sub-transistors T1_1 and T1_2 may transmit the first input signal EM_INS to the first-first control node EM_Q1 in response to the first-first clock sub-signal CK1-1. In an embodiment, the first transistor T1 including first sub-transistors T1_1 and T1_2 may include the sub-transistors connected in series.

The second transistor T2 including second sub-transistors T2_1 and T2_2 may transmit the second low gate voltage VGL2 to the first-first control node EM_Q1 in response to the signal of the first inverting control node EM_QB. In an embodiment, the second transistor T2 including second sub-transistors T2_1 and T2_2 may include the sub-transistors connected in series.

The third transistor T3 may include a gate that receives the high gate voltage VGH, a first electrode connected to the first-first control node EM_Q1, and a second electrode connected to the first-second control node EM_Q2. The third transistor T3 may be an always on transistor (AOT).

The fourth transistor T4 may transmit the second low gate voltage VGL2 to the first inverting control node EM_QB in response to a signal of the first-first control node EM_Q1.

The fifth transistor T5 may transmit the first-second clock signal CK1-2 to a first electrode of the first capacitor C1 in response to a signal of the first-second control node EM_Q2.

The sixth transistor T6 may output the high gate voltage VGH as the first carry signal EM_CR in response to the signal of the first-second control node EM_Q2.

The seventh transistor T7 may transmit the high gate voltage VGH to a first electrode of the ninth transistor T9 in response to the first-first clock signal CK1-1.

The eighth transistor T8 including eighth sub-transistors T8_1 and T8_2 may transmit the first-first clock signal CK1-1 to the first electrode of the ninth transistor T9 in response to the signal of the first-first control node EM_Q1. In an embodiment, the eighth transistor T8 including eighth sub-transistors T8_1 and T8_2 may include the sub-transistors connected in series.

The ninth transistor T9 may include a gate that receives the high gate voltage VGH, the first electrode, and a second electrode connected to a first electrode of the second capacitor C2. The ninth transistor T9 may be an always on transistor (AOT).

The tenth transistor T10 may transmit the first-second clock signal CK1-2 to a second electrode of the second capacitor C2 in response to a signal of the first electrode of the second capacitor C2.

The eleventh transistor T11 may transmit the high gate voltage VGH to the first inverting control node EM_QB in response to a signal of the second electrode of the second capacitor C2.

The thirteenth transistor T13 may output the second low gate voltage VGL2 as the first carry signal EM_CR in response to the signal of the first inverting control node EM_QB.

The fifteenth transistor T15 including sub-transistors T15_1 and T15_2 may transmit the high gate voltage VGH to an intermediate node of the sub-transistors T1_1 and T1_2 of the first transistor T1, an intermediate node of the sub-transistors T2_1 and T2_2 of the second transistor T2, and an intermediate node of the sub-transistors T16_1 and T16_2 of the sixteenth transistor T16 in response to the signal of the first-first control node EM_Q1. In an embodiment, the fifteenth transistor T15 including sub-transistors T15_1 and T15_2 may include the sub-transistors connected in series.

The sixteenth transistor T16 including sub-transistors T16_1 and T16_2 may transmit the first low gate voltage VGL1 to the first-first control node EM_Q1 in response to the reset signal ESR. In an embodiment, the sixteenth transistor T16 including sub-transistors T16_1 and T16_2 may include the sub-transistors connected in series.

The first capacitor C1 may be connected between the gate and the second electrode of the fifth transistor T5. The second capacitor C2 may be connected between the gate and the second electrode of the tenth transistor T10.

The first buffer circuit BC1 may output the first gate signal EM in response to the signal of the first-first control node EM_Q1 and the first-second control node EM_Q2, and the signal of the first inverting control node EM_QB. The first buffer circuit BC1 may include a twelfth transistor T12, a fourteenth transistor T14, a third capacitor C3, and a fourth capacitor C4.

The twelfth transistor T12 may output the high gate voltage VGH as the first gate signal EM in response to the signal of the first-second control node EM_Q2.

The fourteenth transistor T14 may output the first low gate voltage VGL1 as the first gate signal EM in response to the signal of the first inverting control node EM_QB.

The third capacitor C3 may be connected between a gate and a second electrode of the twelfth transistor T12. The fourth capacitor C4 may be connected between a gate and a second electrode of the fourteenth transistor T14.

In an embodiment, each of the transistors included in the first stage ST1 may be an N-type oxide semiconductor transistor. For example, each of the first transistor T1 including sub-transistors T1_1 and T1_2, the second transistor T2 including sub-transistors T2_1 and T2_2, the third transistor T3, the fourth transistor T4, the fifth transistor T5, the sixth transistor T6, the seventh transistor T7, the eighth transistor T8 including sub-transistors T8_1 and T8_2, the ninth transistor T9, the tenth transistor T10, the eleventh transistor T11, the twelfth transistor T12, the thirteenth transistor T13, the fourteenth transistor T14, the fifteenth transistor T15 including sub-transistors T15_1 and T15_2, and the sixteenth transistor T16 including sub-transistors T16_1 and T16_2 included in the first stage ST1 may be the N-type oxide semiconductor transistor.

In an embodiment, an area of the first buffer circuit BC1 may be greater than an area of the first logic circuit LC1. A width of the first buffer circuit BC1 in the second direction DR2 may be greater than a width of the first logic circuit LC1 in the second direction DR2, and a length of the first buffer circuit BC1 in the first direction DR1 may be substantially equal to a length of the first logic circuit LC1 in the first direction DR1. Since the area of the first buffer circuit BC1 is greater than the area of the first logic circuit LC1, even if the number of pixel rows PXR connected to the first stage ST1 (e.g., a load of the first stage ST1) increases, the first gate signal EM may still be stably output to the pixel rows PXR.

The third stage ST3 may be substantially the same as or similar to the first stage ST1 described with reference to FIGS. 9 and 10, except that the third stage ST3 receives a third input signal and the second clock signal CK2 including second clock sub-signals CK2-1 and CK2-2, and outputs the third gate signal EMB and a third carry signal. Accordingly, substantially duplicate description of the third stage ST3 may be omitted.

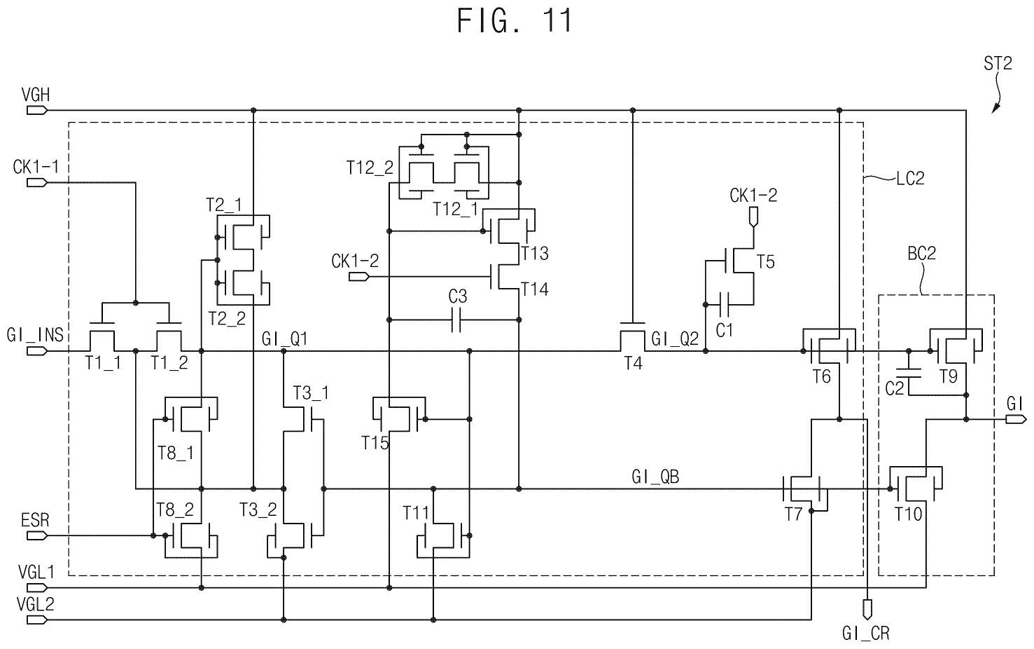

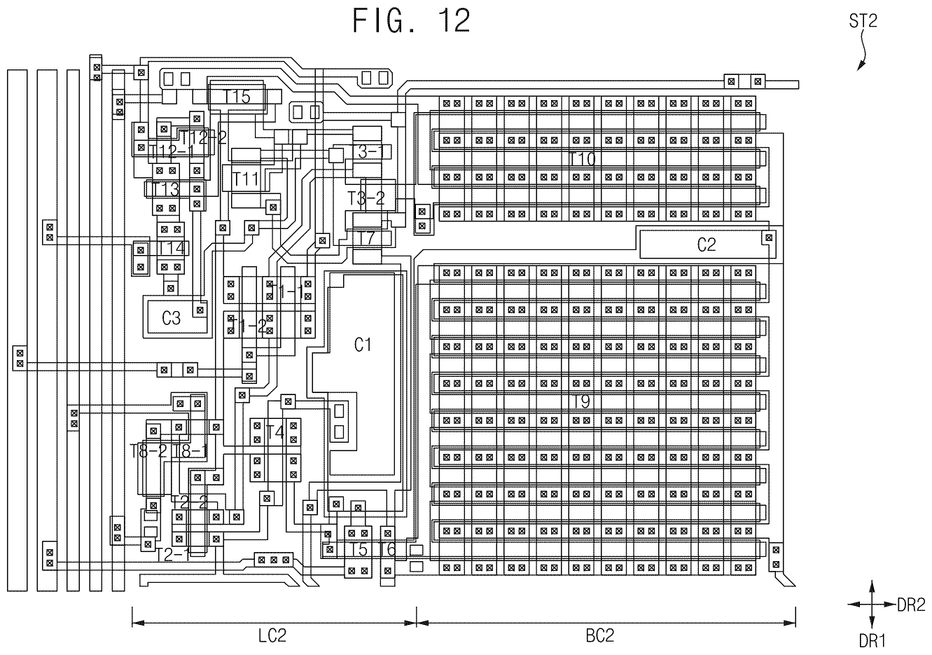

FIG. 11 illustrates the second stage ST2 which provides the second gate signal GI to the pixel PX of FIG. 7. FIG. 12 further illustrates the second stage ST2 of FIG. 11.

Referring to FIGS. 11 and 12, the second stage ST2 may receive a second input signal GI_INS, the first clock signal CK1 including sub-signals CK1-1 and CK1-2, the high gate voltage VGH, the first low gate voltage VGL1, the second low gate voltage VGL2, and the reset signal ESR, and may output the second gate signal GI and a second carry signal GI_CR. The second stage ST2 may include a second logic circuit LC2 and a second buffer circuit BC2.

The second logic circuit LC2 may control a signal of a second-first control node GI_Q1, a signal of a second-second control node GI_Q2, and a signal of a second inverting control node GI_QB, in response to the second input signal GI_INS and the first clock signal CK1 including sub-signals CK1-1 and CK1-2. The second-first control node GI_Q1 and the second-second control node GI_Q2 may be connected in series with a transistor connected between them. The second logic circuit LC2 may include a first transistor T1 including sub-transistors T1_1 and T1_2, a second transistor T2 including sub-transistors T2_1 and T2_2, a third transistor T3 including sub-transistors T3_1 and T3_2, a fourth transistor T4, a fifth transistor T5, a sixth transistor T6, a seventh transistor T7, an eighth transistor T8 including sub-transistors T8_1 and T8_2, an eleventh transistor T11, a twelfth transistor T12 including sub-transistors T12_1 and T12_2, a thirteenth transistor T13, a fourteenth transistor T14, a fifteenth transistor T15, a first capacitor C1, and a third capacitor C3.

The first transistor T1 including sub-transistors T1_1 and T1_2 may transmit the second input signal GI_INS to the second-first control node GI_Q1 in response to the first-first clock sub-signal CK1-1. In an embodiment, the first transistor T1 including sub-transistors T1_1 and T1_2 may include the sub-transistors connected in series.

The second transistor T2 including sub-transistors T2_1 and T2_2 may transmit the high gate voltage VGH to an intermediate node of the first transistor T1 including sub-transistors T1_1 and T1_2, an intermediate node of the third transistor T3's sub-transistors T3_1 and T3_2, and an intermediate node of the eighth transistor T8's sub-transistors T8_1 and T8_2, in response to a signal of the second-first control node GI_Q1. In an embodiment, the second transistor T2's sub-transistors T2_1 and T2_2 may include the sub-transistors connected in series.

The third transistor T3's sub-transistors T3_1 and T3_2 may transmit the second low gate voltage VGL2 to the second-first control node GI_Q1 in response to the signal of the second inverting control node GI_QB. In an embodiment, the third transistor T3's sub-transistors T3_1 and T3_2 may include the sub-transistors connected in series.

The fourth transistor T4 may include a gate that receives the high gate voltage VGH, a first electrode connected to the second-first control node GI_Q1, and a second electrode connected to the second-second control node GI_Q2. The fourth transistor T4 may be an always on transistor (AOT).

The fifth transistor T5 may transmit the first-second clock sub-signal CK1-2 to a first electrode of the first capacitor C1 in response to a signal of the second-second control node GI_Q2.

The sixth transistor T6 may output the high gate voltage VGH as the second carry signal GI_CR in response to the signal of the second-second control node GI_Q2.

The seventh transistor T7 may output the second low gate voltage VGL2 as the second carry signal GI_CR in response to the signal of the second inverting control node GI_QB.

The eighth transistor T8's sub-transistors T8_1 and T8_2 may transmit the first low gate voltage VGL1 to the second-first control node GI_Q1 in response to the reset signal ESR. In an embodiment, the eighth transistor T8 may include sub-transistors T8_1 and T8_2 connected in series.

The eleventh transistor T11 may transmit the second low gate voltage VGL2 to the second inverting control node GI_QB in response to the signal of the second-first control node GI_Q1.

The twelfth transistor T12's sub-transistors T12_1 and T12_2 may each include a gate that receives the high gate voltage VGH, a first electrode that receives the high gate voltage VGH, and a second electrode connected to a first electrode of the third capacitor C3. The twelfth transistor T12's sub-transistors T12_1 and T12_2 may each be an always on transistor (AOT). In an embodiment, the twelfth transistor T12's sub-transistors T12_1 and T12_2 may include the sub-transistors connected in series.

The thirteenth transistor T13 may transmit the high gate voltage VGH to a first electrode of the fourteenth transistor T14 in response to a signal of the second electrode of the twelfth transistor T12's sub-transistors T12_1 and T12_2.

The fourteenth transistor T14 may transmit a signal of the second electrode of the thirteenth transistor T13 to the second inverting control node GI_QB in response to the first-second clock sub-signal CK1-2.

The fifteenth transistor T15 may transmit the first low gate voltage VGL1 to the first electrode of the third capacitor C3 in response to the signal of the second-first control node GI_Q1.

The first capacitor C1 may be connected between the gate and the second electrode of the fifth transistor T5. The third capacitor C3 may have a first terminal connected to each of the second electrode of the twelfth sub-transistor T12_2, the gate of the thirteenth transistor T13, and the second electrode of the fifteenth transistor T15; and the third capacitor C3 may have a second terminal connected to the second inverting control node GI_QB.

The second buffer circuit BC2 may output the second gate signal GI in response to the signal of the second-first control node GI_Q1, the signal of the second-second control node GI_Q2, and the signal of the second inverting control node GI_QB. The second buffer circuit BC2 may include a ninth transistor T9, a tenth transistor T10, and a second capacitor C2.

The ninth transistor T9 may output the high gate voltage VGH as the second gate signal GI in response to the signal of the second-second control node GI_Q2.

The tenth transistor T10 may output the first low gate voltage VGL1 as the second gate signal GI in response to the signal of the second inverting control node GI_QB.

The second capacitor C2 may be connected between the gate and the second electrode of the ninth transistor T9.

In an embodiment, each of the transistors included in the second stage ST2 may be an N-type oxide semiconductor transistor, without limitation thereto. For example, each of the first transistor T1's sub-transistors T1_1 and T1_2, the second transistor T2's sub-transistors T2_1 and T2_2, the third transistor T3's sub-transistors T3_1 and T3_2, the fourth transistor T4, the fifth transistor T5, the sixth transistor T6, the seventh transistor T7, the eighth transistor T8's sub-transistors T8_1 and T8_2, the ninth transistor T9, the tenth transistor T10, the eleventh transistor T11, the twelfth transistor T12's sub-transistors T12_1 and T12_2, the thirteenth transistor T13, the fourteenth transistor T14, and the fifteenth transistor T15 included in the second stage ST2 may be an N-type oxide semiconductor transistor.

In an embodiment, an area of the second buffer circuit BC2 may be greater than an area of the second logic circuit LC2. A width of the second buffer circuit BC2 in the second direction DR2 may be greater than a width of the second logic circuit LC2 in the second direction DR2, and a length of the second buffer circuit BC2 in the first direction DR1 may be substantially equal to a length of the second logic circuit LC2 in the first direction DR1. Since the area of the second buffer circuit BC2 is greater than the area of the second logic circuit LC2, even if the number of pixel rows PXR connected to the second stage ST2 (e.g., a load of the second stage ST2) increases, the second gate signal GI may still be stably output to the pixel rows PXR.

The fourth stage ST4 may be substantially the same as or similar to the second stage ST2 described with reference to FIGS. 11 and 12, except that the fourth stage ST4 receives a fourth input signal and the second clock signal CK2 including sub-signals CK2-1 and CK2-2, and outputs the fourth gate signal GR and a fourth carry signal. Accordingly, substantially duplicate description of the fourth stage ST4 may be omitted.

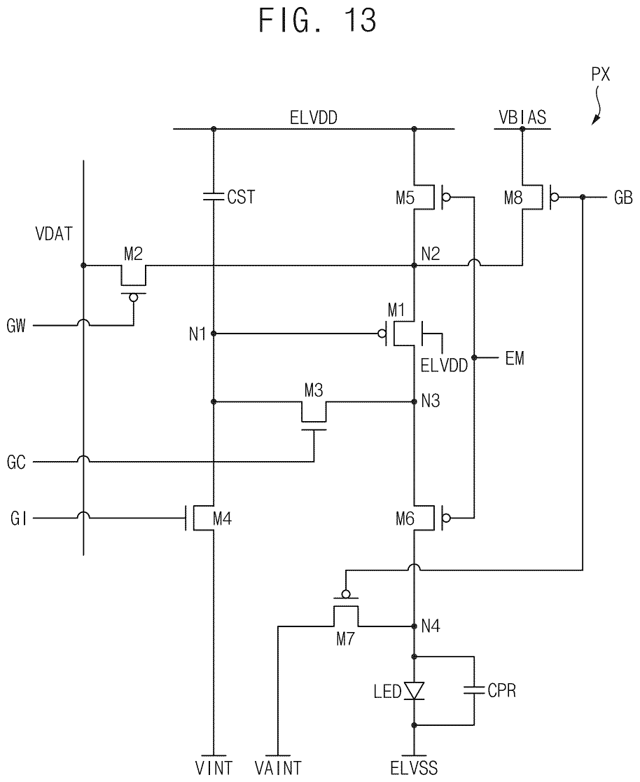

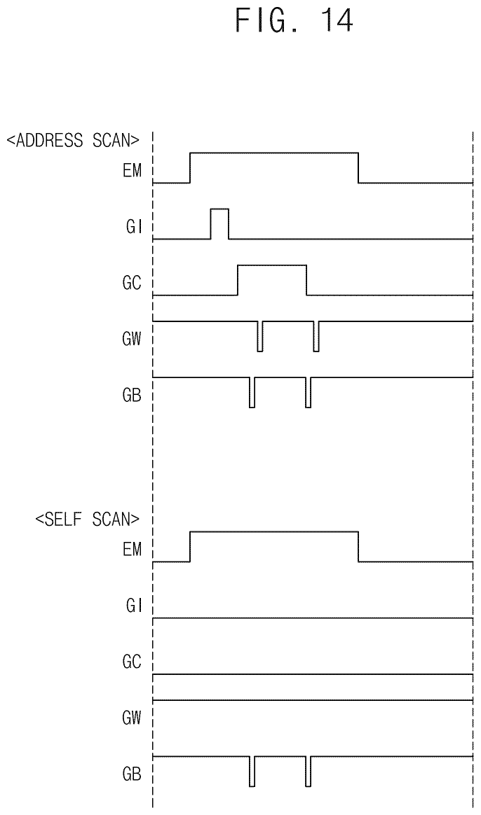

FIG. 13 illustrates an example of the pixel PX of FIG. 1. FIG. 14 illustrates timings of gate signals EM, GI, GC, GW, and GB provided to the pixel PX of FIG. 13.

Referring to FIGS. 13 and 14, the pixel PX may receive a write gate signal GW, a compensation gate signal GC, an initialization gate signal GI, an emission signal EM, a bypass gate signal GB, and the data voltage VDAT. The first gate signal GS1, the second gate signal GS2, the third gate signal GS3, the fourth gate signal GS4, and the fifth gate signal GS5 described with reference to FIGS. 1 to 6 may be the emission signal EM, the bypass gate signal GB, the initialization gate signal GI, the compensation gate signal GC, and the write gate signal GW, respectively, without limitation thereto. As described below with reference to the illustrative examples of FIGS. 13 and 14, EM, GB, GI, GC, and GW represent the first gate signal, the second gate signal, the third gate signal, the fourth gate signal, and the fifth gate signal, respectively.

The pixel PX may include a light-emitting element LED, a first transistor M1 connected to the light-emitting element, a second transistor M2 connected to the first transistor, a third transistor M3 connected to the first transistor, a fourth transistor M4 connected to the third transistor, a fifth transistor M5 connected to the first transistor, a sixth transistor M6 connected to the first transistor, a seventh transistor M7 connected to the sixth transistor, an eighth transistor M8 connected to the second transistor, a storage capacitor CST connected to the third transistor, and a parasitic capacitor CPR connected across the light-emitting element.

The light-emitting element LED may emit light with a luminance corresponding to a driving current. The light-emitting element LED may include a first electrode (e.g., an anode) connected to a fourth node N4 and a second electrode (e.g., a cathode) that receives a second power voltage ELVSS. In an embodiment, the light-emitting element LED may be one of an organic light-emitting diode, an inorganic light-emitting diode, a quantum dot light-emitting diode, and/or a micro light-emitting diode.

The first transistor M1 may control the driving current flowing through the light-emitting element LED. The first transistor M1 may include a gate connected to a first node N1, a first electrode connected to a second node N2, and a second electrode connected to a third node N3. In an embodiment, the first transistor M1 may further include a back gate that receives a first power voltage ELVDD.

The second transistor M2 may provide the data voltage VDAT to the first electrode of the first transistor M1 in response to the fifth gate signal GW. The second transistor M2 may include a gate that receives the fifth gate signal GW, a first electrode that receives the data voltage VDAT, and a second electrode connected to the second node N2.

The third transistor M3 may compensate a threshold voltage of the first transistor M1 in response to the fourth gate signal GC. The third transistor M3 may include a gate that receives the fourth gate signal GC, a first electrode connected to the third node N3, and a second electrode connected to the first node N1.

The fourth transistor M4 may provide a first initialization voltage VINT to the gate of the first transistor M1 in response to the third gate signal GI. The fourth transistor M4 may include a gate that receives the third gate signal GI, a first electrode that receives the first initialization voltage VINT, and a second electrode connected to the first node N1.

The fifth transistor M5 may block a connection between the first electrode of the first transistor M1 and the first power voltage ELVDD in response to the first gate signal EM. The fifth transistor M5 may include a gate that receives the first gate signal EM, a first electrode that receives the first power voltage ELVDD, and a second electrode connected to the second node N2.

The sixth transistor M6 may block a connection between the second electrode of the first transistor M1 and the second power voltage ELVSS in response to the first gate signal EM. The sixth transistor M6 may include a gate that receives the first gate signal EM, a first electrode connected to the third node N3, and a second electrode connected to the fourth node N4.

The seventh transistor M7 may provide a second initialization voltage VAINT to the first electrode of the light-emitting element LED in response to the second gate signal GB. The seventh transistor M7 may include a gate that receives the second gate signal GB, a first electrode that receives the second initialization voltage VAINT, and a second electrode connected to the fourth node N4.

The eighth transistor M8 may provide a bias voltage VBIAS to the first electrode of the first transistor M1 in response to the second gate signal GB. The eighth transistor M8 may include a gate that receives the second gate signal GB, a first electrode that receives the bias voltage VBIAS, and a second electrode connected to the second node N2.

In an embodiment, each of the first transistor M1, the second transistor M2, the fifth transistor M5, the sixth transistor M6, the seventh transistor M7, and the eighth transistor M8 may be a P-type polycrystalline silicon transistor, and each of the third transistor M3 and the fourth transistor M4 may be an N-type oxide semiconductor transistor, without limitation thereto.

The storage capacitor CST may store a signal of the first node N1. The storage capacitor CST may include a first electrode connected to the first node N1 and a second electrode that receives the first power voltage ELVDD.

The parasitic capacitor CPR may be connected in parallel with the light-emitting element LED. The parasitic capacitor CPR may be an internal capacitor of the light-emitting element LED.

In an address scan period in which the data voltage VDAT is written to the pixel PX, each of the first, third, and fourth gate signals EM, GI, and GC may include a pulse, and each of the second and fifth gate signals GB and GW may include two pulses. In the address scan period, the first transistor M1 may be initialized by the pulse of the third gate signal GI, the threshold voltage of the first transistor M1 may be compensated in a diode-connection manner by the pulse of the fourth gate signal GC, the data voltage VDAT may be written to the first transistor M1 by the pulses of the fifth gate signal GW, the light-emitting element LED may be initialized and the first transistor M1 may be on-biased by the pulses of the second gate signal GB, and the driving current corresponding to the data voltage VDAT may flow through the light-emitting element LED by the pulse of the first gate signal EM.

In a self-scan period in which the data voltage VDAT is not written to the pixel PX, the first gate signal EM may include a pulse, the second gate signal GB may include two pulses, and each of the third to fifth gate signals GI, GC and GW need not include a pulse. In the self-scan period, the light-emitting element LED may be initialized and the first transistor M1 may be on-biased by the pulses of the second gate signal GB, and the driving current corresponding to the data voltage VDAT written in the address scan period may flow through the light-emitting element LED by the pulse of the first gate signal EM.

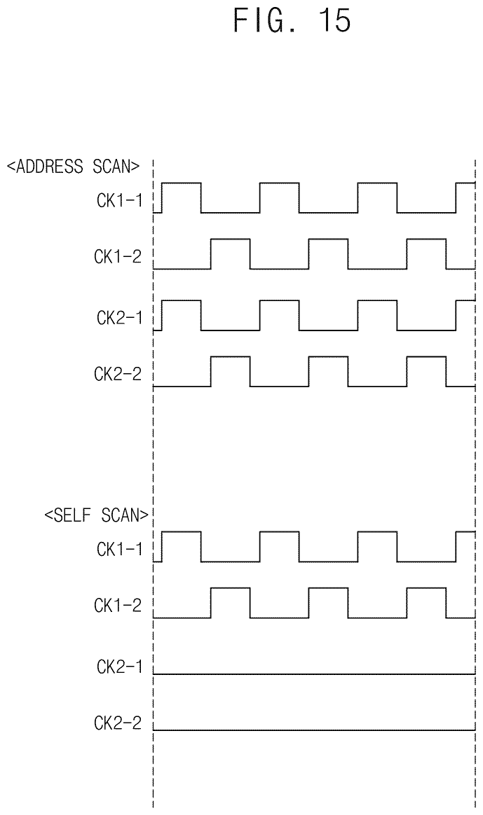

FIG. 15 illustrates timings of clock sub-signals CK1-1, CK1-2, CK2-1, and CK2-2 according to an embodiment.

Referring to FIG. 15, the first-first clock sub-signal CK1-1 and the first-second clock sub-signal CK1-2 may swing between a low level and a high level in the address scan period and the self-scan period. As illustrated in FIGS. 8 and 14, each of the first gate signal EM and the second gate signal GI of FIG. 8 and GB of FIG. 14 may include a pulse in the address scan period and the self-scan period, and each of the first and second gate drivers 121 and 122 may generate a pulse of a gate signal based on the first-first clock sub-signal CK1-1 and the first-second clock sub-signal CK1-2 that each swings between the low level and the high level in the address scan period and the self-scan period.

The second-first clock sub-signal CK2-1 and the second-second clock sub-signal CK2-2 may swing between the low level and the high level in the address scan period, and may maintain the low level or the high level in the self-scan period. As illustrated in FIGS. 8 and 14, each of the third gate signal EMB of FIG. 8 and GI of FIG. 14, and the fourth gate signal GR of FIG. 8 and GC of FIG. 14, may include a pulse in the address scan period, and need not include a pulse in the self-scan period, and each of the third and fourth gate drivers 123 and 124 may generate a pulse of a gate signal based on the second-first clock sub-signal CK2-1 and the second-second clock sub-signal CK2-2 that swings between the low level and the high level in the address scan period, and need not generate a pulse of the gate signal based on the second-first clock sub-signal CK2-1 and the second-second clock sub-signal CK2-2 that maintains the low level or the high level in the self-scan period. As the second-first clock sub-signal CK2-1 and the second-second clock sub-signal CK2-2 maintains the low level or the high level in the self-scan period, the power consumption of the gate driver 120 may be minimized.

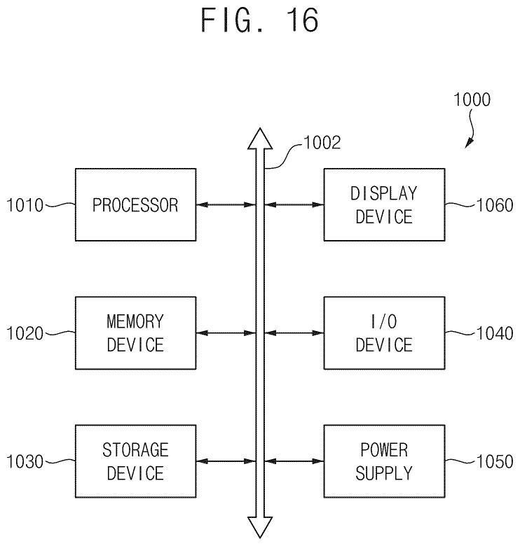

FIG. 16 illustrates an electronic apparatus 1000 according to an embodiment.

Referring to FIG. 16, the electronic apparatus 1000 may include a processor 1010, a memory device 1020 connected to a bus 1002, a storage device 1030 connected to the bus, an input/output (I/O) device 1040 connected to the bus, a power supply 1050 connected to the bus, and a display device 1060 connected to the bus. The electronic apparatus 1000 may further include a plurality of ports capable of communicating with a video card, a sound card, a memory card, a USB device, and/or the like, or communicating with other systems.

The processor 1010 may perform specific calculations or tasks. In an embodiment, the processor 1010 may be a microprocessor, a central processing unit (CPU), and/or the like. The processor 1010 may be connected to other components through an address bus, a control bus, a data bus, and/or the like. In an embodiment, the processor 1010 may also be connected to an expansion bus such as a peripheral component interconnect (PCI) bus. In an embodiment, the processor 1010 may generate the image data IMG of FIG. 1 and the control signal CTRL of FIG. 1, and may provide the image data IMG and the control signal CTRL to the display device 1060.

The memory device 1020 may store data associated with an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random-access memory (PRAM), a resistance random-access memory (RRAM), a nano floating gate memory (NFGM), a polymer random-access memory (PoRAM), a magnetic random-access memory (MRAM), and/or a ferroelectric random-access memory (FRAM); and/or a volatile memory device such as a dynamic random-access memory (DRAM), a static random-access memory (SRAM), and/or a mobile DRAM.

The storage device 1030 may include a solid-state drive (SSD), a hard disk drive (HDD), a CD-ROM, and/or the like. The I/O device 1040 may include: an input device such as a keyboard, a keypad, a touch pad, a touch screen, and/or a mouse; and an output device such as a speaker and/or a printer. The power supply 1050 may supply a power sufficient for the operation of the electronic apparatus 1000. The display device 1060 may be connected to other components through the bus 1002 and/or other buses or communications links. The display device 1060 may correspond to the display device 100 of FIG. 1. The display device 1060 may display an image based on the image data IMG.

In a gate driver included in the display device 1060, stages of first and second gate drivers are alternately arranged in a column direction, each of the stages of the first and second gate drivers is connected to at least four pixel rows, and power consumption and/or an area of the gate driver may be minimized. The display device 1060 includes the gate driver with the minimized power consumption and minimized area, and power consumption and a dead space of the display device 1060 may also be minimized. Further, the electronic apparatus 1000 includes the display device 1060 with the minimized power consumption, and power consumption of the electronic apparatus 1000 may also be minimized.

A display device according to an embodiment may be applied to a display device included in a computer, a notebook, a mobile phone, a smart phone, a smart pad, a smart watch, a PMP, a PDA, an MP3 player, and/or the like.

Although the gate driver, the display device, and the electronic apparatus according to illustrative embodiments have been described by way of example with reference to the drawings, embodiments may be modified and changed by a person of ordinary skill in the pertinent art or technical field without departing from the technical scope and spirit as bounded by the following claims.

What is claimed is:

1. A display device comprising:
a display panel including a plurality of pixel rows arranged in a first direction, each pixel row including a plurality of pixels;
a first gate driver including a first stage having a first gate signal as a first output to each of the plurality of pixel rows; and
a second gate driver including a second stage having a second gate signal as a second output to each of the plurality of pixel rows, the second stage being alternately arranged with the first stage in the first direction,
wherein the first gate driver and the second gate driver share a first clock signal, and
wherein each of the first stage and the second stage is connected to at least four pixel rows among the plurality of pixel rows.

2. The display device of claim 1, wherein each of the first stage and the second stage is connected to an even number of pixel rows among the plurality of pixel rows.

3. The display device of claim 2, wherein each of the first stage and the second stage is connected to four, six, or eight pixel rows among the plurality of pixel rows.

4. The display device of claim 1, further comprising:
a third gate driver including a third stage having a third gate signal as a third output to each of the plurality of pixel rows; and
a fourth gate driver including a fourth stage having a fourth gate signal as a fourth output to each of the plurality of pixel rows, the fourth stage being alternately arranged with the third stage in the first direction,
wherein the third gate driver and the fourth gate driver share a second clock signal, and
wherein each of the third stage and the fourth stage is connected to at least four pixel rows among the plurality of pixel rows.

5. The display device of claim 4, wherein the first gate driver, the second gate driver, the third gate driver, and the fourth gate driver are positioned towards a first side of the plurality of pixel rows in a second direction crossing the first direction.

6. The display device of claim 4, wherein the first gate driver and the second gate driver are positioned towards a first side of the plurality of pixel rows in a second direction crossing the first direction, and
wherein the third gate driver and the fourth gate driver are positioned towards a second side of the plurality of pixel rows opposite to the first side in the second direction.

7. The display device of claim 4, further comprising:
a fifth gate driver including a fifth stage having a fifth gate signal as a fifth output to the plurality of pixel rows,
wherein the fifth stage includes a plurality of sub-stages, each of which is connected to one respective pixel row among the plurality of pixel rows.

8. The display device of claim 7, wherein each of the pixels includes:
a light-emitting element;
a first transistor which controls a driving current flowing through the light-emitting element;
a second transistor which provides a data voltage to a gate of the first transistor in response to the fifth gate signal;
a third transistor which provides a reference voltage to the gate of the first transistor in response to the fourth gate signal;
a fourth transistor which provides an initialization voltage to a first electrode of the light-emitting element in response to the second gate signal;
a fifth transistor which blocks a connection between a first electrode of the first transistor and a first power voltage in response to the first gate signal; and
a sixth transistor which blocks a connection between a second electrode of the first transistor and a second power voltage in response to the third gate signal.

9. The display device of claim 7, wherein each of the pixels includes:
a light-emitting element;
a first transistor which controls a driving current flowing through the light-emitting element;
a second transistor which provides a data voltage to a gate of the first transistor in response to the fifth gate signal;
a third transistor which compensates a threshold voltage of the first transistor in response to the fourth gate signal;
a fourth transistor which provides an initialization voltage to the gate of the first transistor in response to the third gate signal;
a fifth transistor which blocks a connection between a first electrode of the first transistor and a first power voltage in response to the first gate signal;
a sixth transistor which blocks a connection between a second electrode of the first transistor and a second power voltage in response to the first gate signal; and
a seventh transistor which provides a second initialization voltage to a first electrode of the light-emitting element in response to the second gate signal.

10. The display device of claim 9, wherein each of the pixels further includes:
an eighth transistor having a bias voltage as a bias output to the first electrode of the first transistor in response to the second gate signal.

11. The display device of claim 4, wherein the first clock signal swings between a low level and a high level in an address scan period and a self-scan period, and
wherein the second clock signal swings between the low level and the high level in the address scan period, and maintains the low level or the high level in the self-scan period.

12. The display device of claim 1, wherein the first stage includes:
a first logic circuit which controls a signal of a first control node and a signal of a first inverting control node in response to a first input signal and the first clock signal; and
a first buffer circuit which outputs the first gate signal in response to the signal of the first control node and the signal of the first inverting control node, and
wherein a width of the first buffer circuit in a second direction crossing the first direction is greater than a width of the first logic circuit in the second direction.

13. The display device of claim 12, wherein the second stage includes:
a second logic circuit which controls a signal of a second control node and a signal of a second inverting control node in response to a second input signal and the first clock signal; and
a second buffer circuit which outputs the second gate signal in response to the signal of the second control node and the signal of the second inverting control node, and
wherein a width of the second buffer circuit in the second direction is greater than a width of the second logic circuit in the second direction.

14. The display device of claim 1, wherein each of the first stage and the second stage includes a plurality of transistors, and
wherein each of the transistors is an N-type oxide semiconductor transistor.

15. A gate driver comprising:
a first gate driver including a first stage having a first gate signal as a first output to each of a plurality of pixel rows; and
a second gate driver including a second stage having a second gate signal as a second output to each of the plurality of pixel rows, the second stage being alternately arranged with the first stage in a first direction,
wherein the first gate driver and the second gate driver share a first clock signal, and
wherein each of the first stage and the second stage is connected to at least four pixel rows among the plurality of pixel rows.

16. The gate driver of claim 15, further comprising:
a third gate driver including a third stage having a third gate signal as a third output to each of the plurality of pixel rows; and
a fourth gate driver including a fourth stage having a fourth gate signal as a fourth output to each of the plurality of pixel rows, the fourth stage being alternately arranged with the third stage in the first direction,
wherein the third gate driver and the fourth gate driver share a second clock signal, and
wherein each of the third stage and the fourth stage is connected to at least four pixel rows among the plurality of pixel rows.

17. The gate driver of claim 16, further comprising:
a fifth gate driver including a fifth stage having a fifth gate signal as a fifth output to the plurality of pixel rows,
wherein the fifth stage includes a plurality of sub-stages, each of which is connected to one respective pixel row among the plurality of pixel rows.

18. The gate driver of claim 16, wherein the first clock signal swings between a low level and a high level in an address scan period and a self-scan period, and
wherein the second clock signal swings between the low level and the high level in the address scan period, and maintains the low level or the high level in the self-scan period.

19. The gate driver of claim 15, wherein the first stage includes:
a first logic circuit which controls a signal of a first control node and a signal of a first inverting control node in response to a first input signal and the first clock signal; and
a first buffer circuit which outputs the first gate signal in response to the signal of the first control node and the signal of the first inverting control node,
wherein a width of the first buffer circuit in a second direction crossing the first direction is greater than a width of the first logic circuit in the second direction.

20. An electronic apparatus comprising:
a processor which generates image data; and
a display device which displays an image based on the image data,
wherein the display device comprises:
a display panel including a plurality of pixel rows arranged in a first direction and each including a plurality of pixels;
a first gate driver including a first stage having a first gate signal as a first output to each of the plurality of pixel rows; and
a second gate driver including a second stage having a second gate signal as a second output to each of the plurality of pixel rows, the second stage being alternately arranged with the first stage in the first direction,
wherein the first gate driver and the second gate driver share a first clock signal, and
wherein each of the first stage and the second stage is connected to at least four pixel rows among the plurality of pixel rows.
